(19) United States
(12) Patent Application Publication
(10) Pub. No.: US 2016/0083596 A1
(43) Pub. Date: Mar. 24, 2016

(54) LED CURABLE INKJET INKS HAVING UV ABSORBERS, AND ASSOCIATED SYSTEMS AND PROCESSES

(71) Applicant: ELECTRONICS FOR IMAGING, INC., Fremont, CA (US)

(72) Inventor: Joshua SAMUEL, Ann Arbor, MI (US)

(21) Appl. No.: 14/490,559

(22) Filed: Sep. 18, 2014

(51) Int. Cl. C09D 11/30; G02B 5/00; C09D 133/04

(52) U.S. Cl. CPC C09D 11/30; C09D 133/04; G02B 5/003

(57) ABSTRACT

Enhanced inks, and associated systems and processes are disclosed, wherein one or more enhanced inkjet layers are established in a work piece, i.e. a substrate. One or more of the inks comprise a selective photo absorber that allows UV curing, while absorbing incident UV light after production. In some embodiments, the selective photo absorber can be configured to absorb light at wavelengths less than 380 nm, while a photoinitiator in the ink can be activated by light having an average wavelength that is equal to or greater than 380 nm. Incident UVA and UVB light is readily absorbed by the cured enhanced ink layer, thus minimizing deleterious effects such as any of yellowing, loss of gloss, or cracking. The selective photo absorber can be used in one or more layers, and can be used on an outer protective inkjet layer.

### FIELD OF THE INVENTION

The invention relates to the field of printing systems, structures, and associated processes. More particularly, the invention relates to improved inks for use in printing systems.

### BACKGROUND OF THE INVENTION

Broad-spectrum ultraviolet radiation (UVR) includes three wavelength ranges, comprising UVA light, having a wavelength range of about 320 nm to 400 nm, UVB light, having a wavelength range of about 290 nm to 320 nm, and UVC light, having a wavelength range of 100 nm to 280 nm. Solar UV energy that reaches Earth comprises primarily UVA light, with a small amount of UVB light. No UVC light from solar radiation reaches the earth's surface, since UVC radiation is completely absorbed in the upper atmosphere, by ozone, molecular oxygen, and water vapor.

FIG. 1 shows an exemplary conventional print job 10, comprising one or more layers 16, e.g. 16a-16e, of conventional ink that may be jetted onto a surface 14, e.g. 14a, of a substrate 12, wherein each of the layers 16 are typically cured by application of UV energy, which activates a photoinitiator that is included in the jetted ink. Print jobs that are produced using ultraviolet (UV) curable inkjet inks are commonly affected over time, by exposure to light.

In conventionally cured inks and coatings, an arc lamp, with various types of undoped mercury or doped mercury lamps are used. These lamps emit light over a wide range of wavelengths, such as in the UVA spectrum, the UVB spectrum, and/or the UVC spectrum. This light is used to initiate cure reactions, using photoinitiators that absorb light in the emitted range.

As seen in FIG. 1, light 20 can have one or more adverse effects 22 on such print jobs 10. For example, pigments within the ink, even those that are considered to be stable to light, often fade over time, due to photo bleaching. Furthermore, light 20 can adversely affect 22 the acrylic polymer matrix that is formed when the ink is cured, and/or the underlying substrate 12, which can result in undesired effects 22, such as yellowing 22, and over time, changes in gloss and/or physical changes, e.g. cracking.

Weathering of inks and coatings often happens with exposure to light that can break bonds in the polymers or pigments. For example, many polymers are sensitive and degrade in the 290-345 nm range, and sunlight that reaches the earth has appreciable intensity at wavelengths above 300 nm.

Currently, photo absorbers are often used to protect coatings and prints that are thermally or oxidatively cured. Photo absorbers are materials that absorb light that can otherwise lead to detrimental reactions, such as degradation. These materials are configured to absorb light in the ultraviolet (UV) spectrum, and do not affect the color of the coating or print.

FIG. 2 is an exemplary graph 26 of deleterious affects of degradation of quality 28, due to incident light, as a function of time 30, for a coating or print 10 that is thermally or oxidatively cured, with 36 and without 34 the addition of UV absorption additive. As seen in FIG. 2, the quality 28 of a coating may degrade rapidly from exposure to incident light. Degradation of such coatings and print jobs 10 becomes even more pronounced with increasing exposure to light, such as if when the work product is located outdoors. As seen in the second graph 36 of FIG. 2, a print job 10 that includes a photo absorber is configured to maintain print quality 28 as a function of time 30, by reducing the deleterious effects of incident light.

Acrylate coatings that are cured with e-beams can also use photo absorbers, without concern for a reduction in the cure rate.

In contrast to printers that provide thermal or oxidative curing, many current print systems are configured to cure ink with UV light, wherein the inks contain photoinitiators to initiate curing when controllably exposed to the light. The majority of these printers to date have used doped or undoped mercury arc lamps to generate sufficient UV light to initiate curing. The arc lamps generate a broad spectrum of light where a large part of the available light energy is generated at wavelengths lower than 380 nm.

In the last few years, there has been increasing use of LED lamps as sources of UV light. These LED sources are narrow in bandwidth. The most powerful LED lamps currently available generate light with the band centered around 380 to 400 nm.

While UV absorbers are commonly used in other printing environments, to block harmful light from affecting prints or coatings, the use of such UV absorbers would block UV light that is used for curing in conventionally cured print systems, and hence cannot be used effectively to protect such prints from the ambient light that causes degradation. This is because the majority of the energy available for curing in arc lamps overlaps the wavelengths that cause photodegradation of the film, and are blocked by UV absorbers, While small amounts of UV absorbers may be used, while still allowing curing, the use of greater amounts of UV absorbers, such as to lend full protection for the print, does not enable curing.

Therefore, conventional UV print systems often use other methods of protection to increase the photostability of their prints, such as using radical scavengers within the ink. However, such methods do not fully replace the use of UV absorbers.

It would therefore be advantageous to provide an LED curable ink that may be used in print systems that comprise UV curing, wherein the LED curable ink includes a photo absorber that increases the photostability of the resulting print job, while retaining full curability from LED light sources. The development of such an LED curable ink would be a major technological breakthrough.

It would also be advantageous to provide such an LED curable ink that is readily configured to be used in a wide variety of print systems and associated processes, without undue modification. The development of such an LED curable ink would constitute a further technological advance.

### SUMMARY OF THE INVENTION

Enhanced ink compositions, and associated systems and processes are disclosed, wherein one or more enhanced inkjet layers are established in a work piece, i.e. a substrate, wherein one or more of the inkjet layers comprise a selective photo absorber that allows UV curing, while absorbing incident UV light after production. For example, in some embodiments the selective photo absorber can be configured to absorb light at wavelengths less than 380 nm, while a photoinitiator in the ink can be configured to be controllably activated by light having an average wavelength that is equal to or greater than 380 nm. Subsequent exposure of the work piece to incident UVA and UVB light, having an average light spectrum of less than 380 nm, is readily absorbed by the layer, thus minimizing deleterious effects such as any of yellowing, loss of gloss, or cracking. The selective photo absorber can be used in one or more layers, such as for any of pigmented or unpigmented layers. In some embodiments, the selective photo absorber can be used on an outer protective inkjet layer. The enhanced inks can be configured for a wide variety of printing systems having UV curing mechanisms. The enhanced ink may also preferably be configured for printing systems having UV pinning.

### BRIEF DESCRIPTION OF THE DRAWINGS

FIG. 1 shows an exemplary conventional print job that is subjected to light;

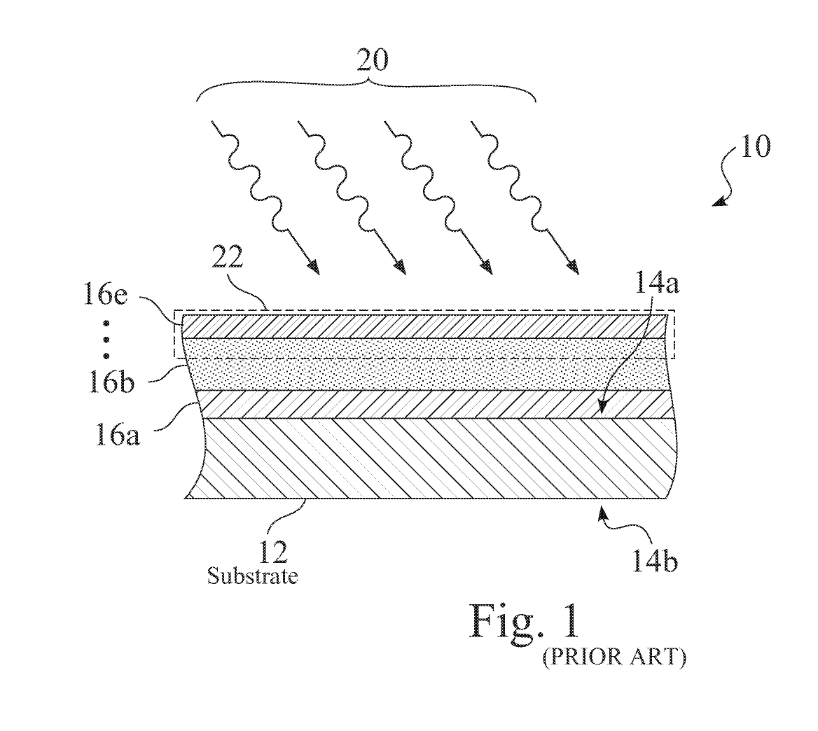

FIG. 2 shows an exemplary graph of deleterious affects of degradation of a print job over time, as a function of incident light, with and without the addition of UV absorption additive;

FIG. 3 shows a partial cross section of a print job having one or more enhanced ink layers;

FIG. 4 is a schematic diagram of an exemplary enhanced ink composition;

FIG. 5 is a chart that shows absorbance as a function of wavelength for an exemplary ink additive having relatively low absorption of light in a curing spectrum, and relatively high absorption of light in an ambient spectrum;

FIG. 6 is a schematic diagram of an exemplary system for delivering and curing one or more layers of enhanced ink;

FIG. 7 is a schematic diagram of an alternate exemplary system for delivering and curing one or more layers of enhanced ink;

FIG. 8 is a schematic diagram of an exemplary system for delivering and curing one or more layers of enhanced ink, wherein the substrate is supported on a platen;

FIG. 9 is a flowchart of an exemplary process for delivering and curing one or more layers of enhanced ink; and

FIG. 10 is a high-level block diagram showing an example of a processing device that can represent any of the systems described herein.

### DETAILED DESCRIPTION OF PREFERRED EMBODIMENTS

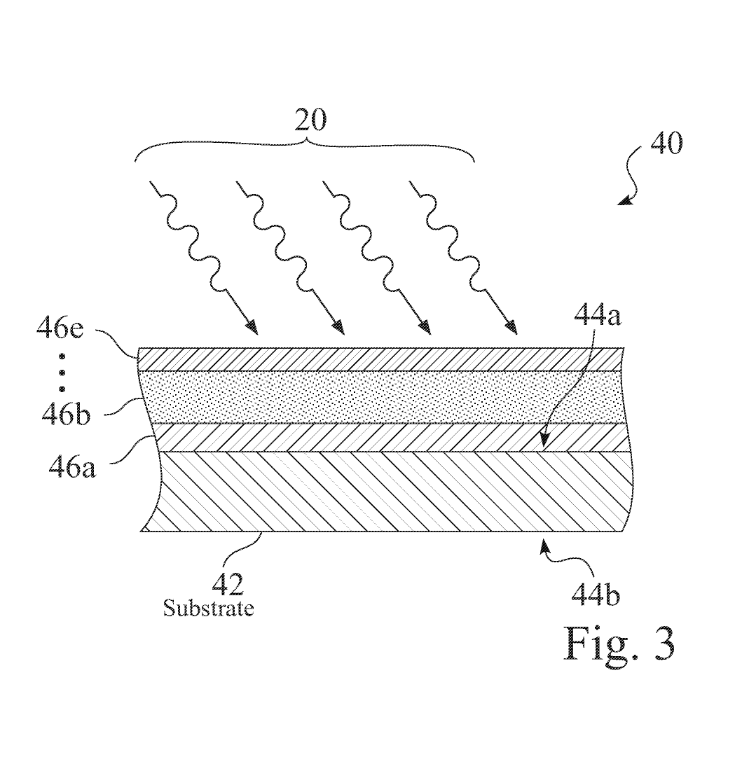

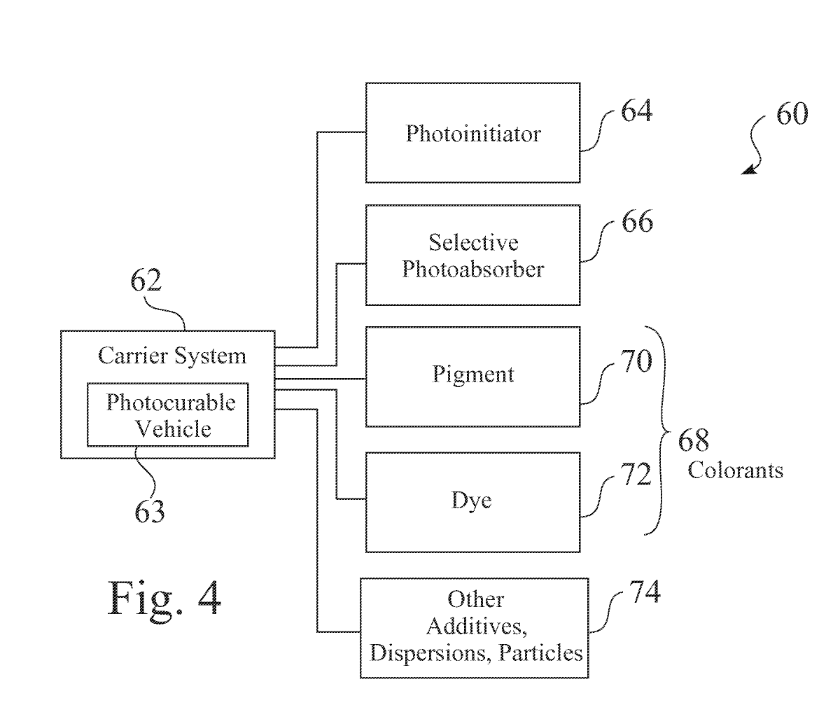

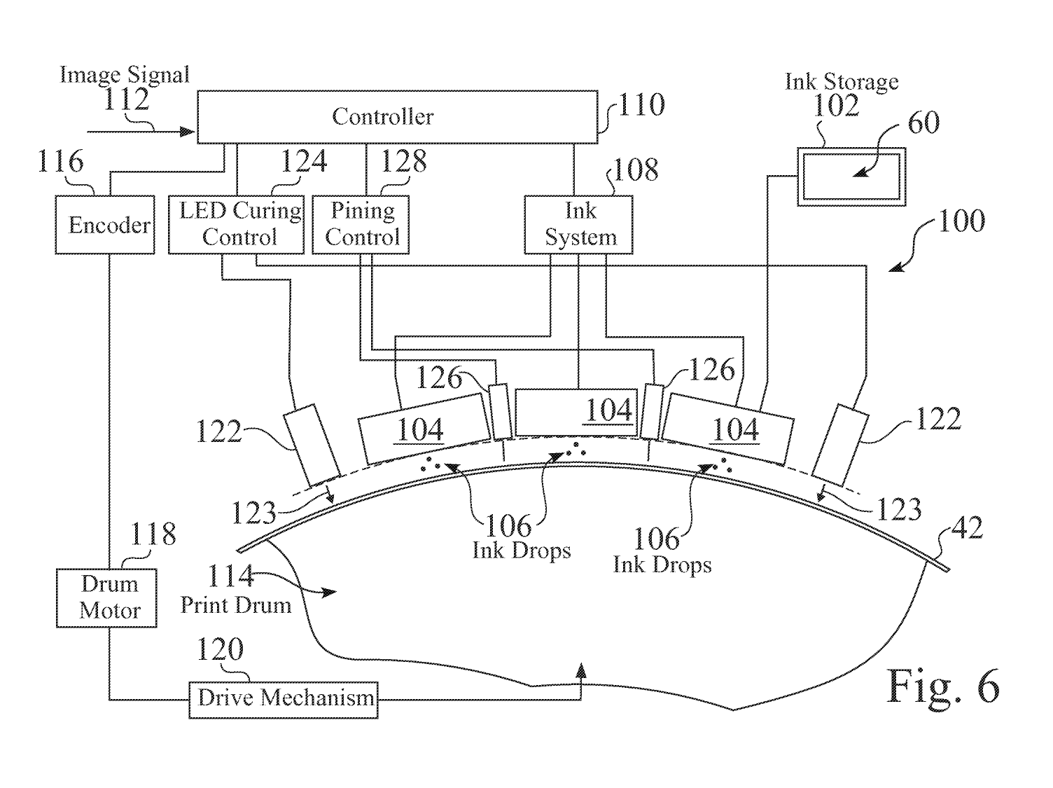

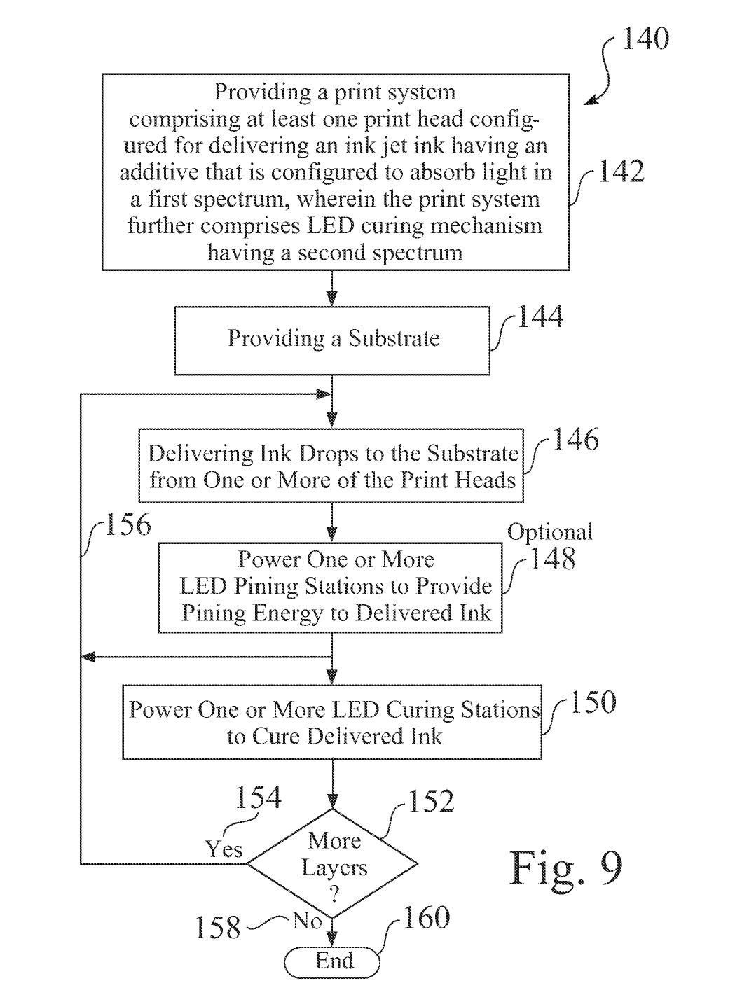

FIG. 3 shows a partial cross section of a print job 40 having one or more ink layers 46, e.g. 46a-46e, on at least one surface 44, e.g. 44a, of a substrate 42, wherein one or more of the ink layers 46 comprises ink 60 (FIG. 4) that is enhanced with the inclusion of a selective photo absorber 66 (FIG. 4). The selective photo absorber 66 is configured to allow curing 150 (FIG. 9) from exciting light 123 (FIG. 6) delivered from a light source 122, e.g. LED curing assemblies 122 (FIG. 6), while allowing increased photostability for the finished, i.e. cured, print job 40 when subjected to light 20.

In some embodiments, each of the ink layers 46 is enhanced with a selective photo absorber 66. In some alternate embodiments, only the top layer 46, e.g. 46e, such as an LED curable clear coat 46e, is enhanced with a selective photo absorber 66, such as to provide a protective upper layer that is configured to substantially absorb incident UVA and UVB light. In some embodiments, at least the first layer 46a is enhanced with a selective photo absorber 66, such as to provide an undercoat layer 46a that substantially protects a work piece 42 from incident UVA and UVB light.

FIG. 4 is a schematic diagram of an exemplary enhanced ink composition 60, which comprises at least a photoinitiator 64 and a selective photo absorber 66 within a suitable carrier system 62, having a photocurable vehicle 63. The enhanced ink composition 60 may be substantially colorless, or may include one or more colorant 68, such as any of one or more dyes 72, one or more pigments 70, and/or any mixture thereof. In some embodiments, the enhanced ink composition 60 may comprise other additives, dispersions, and/or particles 74, and/or other components that protect from photodegradation of the films, such as but not limited to hindered amine light stabilizers (HALS).

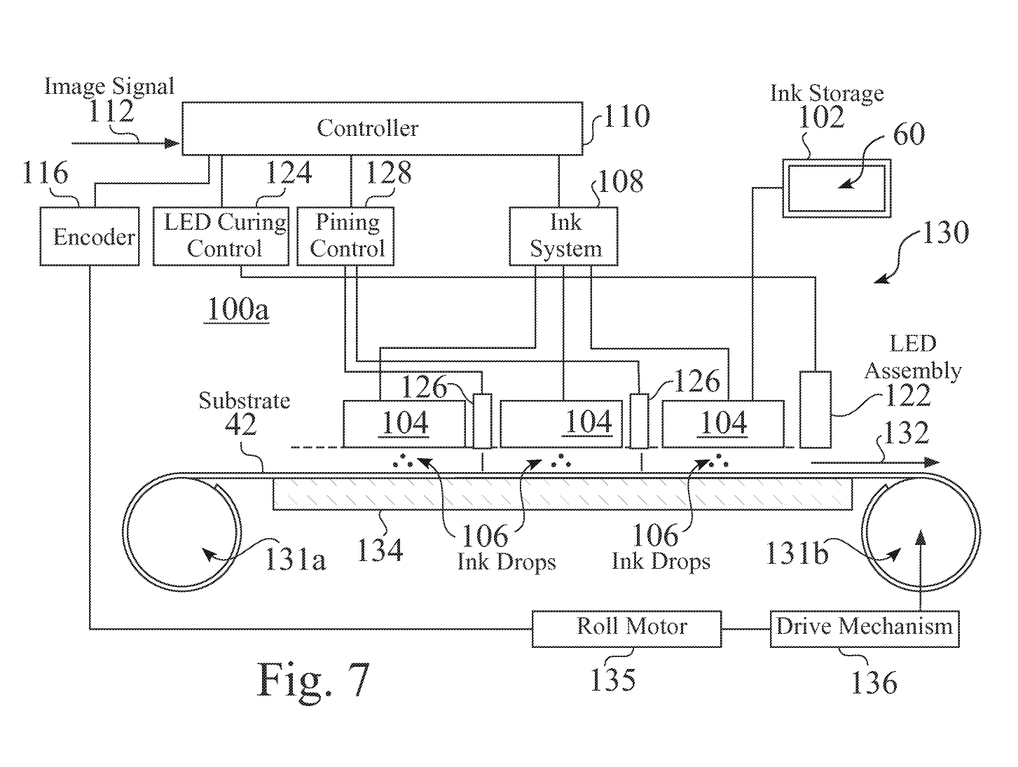

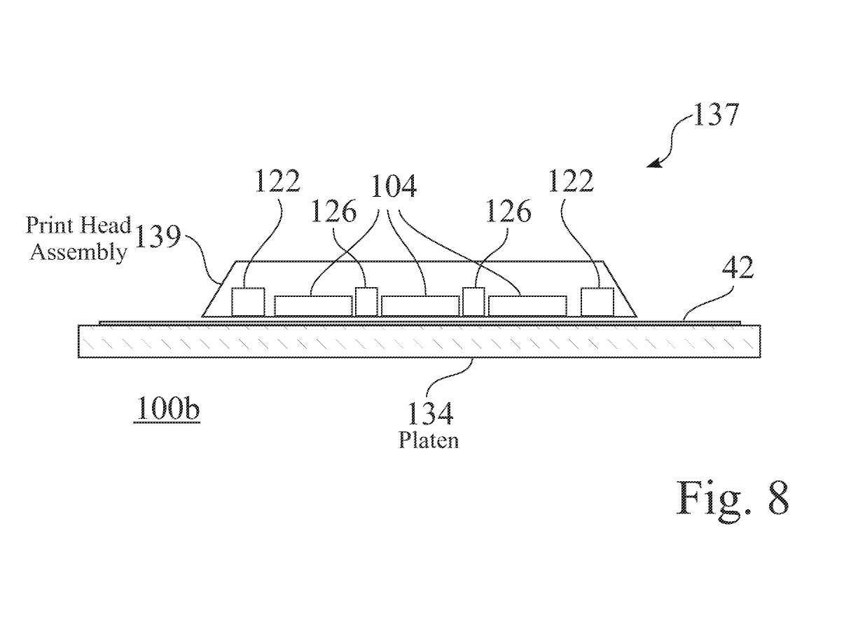

The carrier system 62 is largely a photocurable resin, comprised of a selection of monomers and oligomers selected so as to have the correct physical properties to be jetted from a print head 104. The carrier system 62 is also typically selected to yield the required physical properties after cure, and to cure at sufficiently high speeds for the printer 100 (FIG. 6, FIG. 7, FIG. 8). While the carrier system 62, i.e. a photocurable vehicle 62, is normally comprised of a mixture of (meth)acrylates, the carrier system 62 can comprise any photo-polymerizable chemistry.

In some embodiments of enhanced print jobs 40, a outer layer, e.g. 46e, can comprise a substantially colorless layer 46, such as to protect one or more prior layers 46, 46a-46d, and/or the substrate 42 itself. In such embodiments, the protective outer layer 46, e.g. 46e, can be any of transparent, especially clear, or substantially clear. As well, the protective outer layer 46 can be configured to provide any of a matte, semi-gloss, or glossy appearance.

For embodiments of enhanced inks that include one or more colorants 68, the number and kinds of colorants can depend upon the enhanced ink 60 being formulated. In some embodiments, the enhanced ink 60 can comprise Thorn about 2 percent to about 10 percent of colorant, by weight of the composition. The amount of pigment can depend, at least in part, on the colorant 68 used.

Some embodiments of enhanced inks 60 can comprise one or more colorants 68 that are based upon a set of colorants, such as but not limited to a set comprising cyan, magenta, yellow, and black (CMYK) colorants 68. Other embodiments of enhanced inks 60 can comprise more complicated colorant packages, and can be formulated in many colors, including colors that can be configured to provide other qualities, such as but not limited to metallic or pearlescent qualities. Some combinations of the enhanced inks 60 can be configured to print full color variable images on a substrate 40.

Various inorganic and organic dyes 72 and/or pigments 70 can be used with the enhanced ink 60. In general, pigments 70 can have a maximum particle size that is small enough to avoid clogging the ink jets during printing. As well, the pigments 70 can have a narrow particle size distribution. Non-limiting examples of pigments 70 that can be useful with some embodiments of enhanced inks 60 can comprise any of CI Pigment Yellow 74, 93, 95, 109, 110, 120, 128, 138, 139, 151, 154, 155, 173, 180, 185, and 193; C.I. Pigment Orange 34, 36, 43, 61, 63, and 71; C.1. Pigment Red 122, 202, 254; CI Pigment Blue 15:3, 15:4; C.I. Pigment Violet 19, 23, and 33; and C.I. Pigment Black 7. Non-limiting examples of dyes 72 that can be useful with some embodiments of enhanced inks 60 comprise any of Orasol yellow 2RLN, Orasol yellow 2GLN-M, Savinyl yellow, Savinyl scarlet RLS, Orasol red BL, and Orasol blue GN.

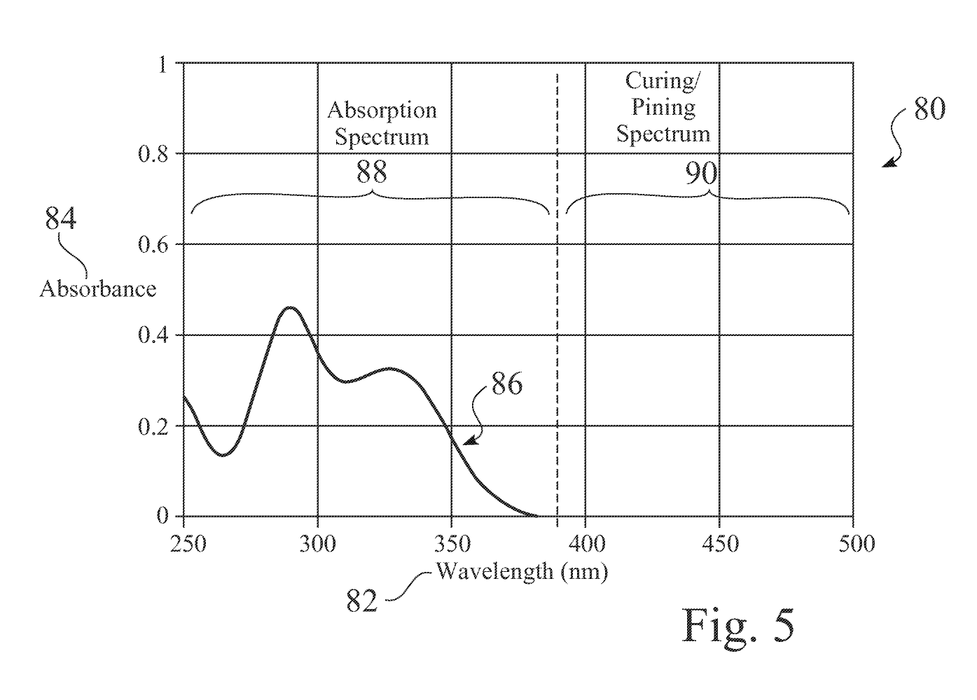

FIG. 5 is a chart 80 that shows absorbance 84 as a function of wavelength 82 for an exemplary selective photo absorber 66 having relatively low absorption of light in a curing spectrum 90, and relatively high absorption of light, e.g. 20, in an ambient spectrum 88.

For example, the enhanced ink 60 can comprise a selective photo absorber 66 that is configured to absorb light in a region 88 that is mainly below 390 nanometers. Such an enhanced ink 60 can readily be used in a inkjet printing system 100 for which the exciting cure light 123 (FIG. 6) comprises one or more light emitting diodes (LEDs) 122 that have a light spectrum 90 is centered at 390 nm and above.

Under these conditions, the light absorption of the UV light absorber 66 does not interfere with the exciting light 123 that is activated to cure 150 the jetted ink film 46, e.g. 46e. The light absorber 66 can be added in high concentrations, thus protecting the polymers and pigments, all which tend to absorb light strongly below 390 nm. For example, polypropylene bonds are affected by light that has a wavelength lower than 370 nm. The selected light absorbers 66 filter out the more energetic low wavelength light 20, and thus protect the film 46 and pigments from photo degradation.

The exemplary absorption data 86 seen in FIG. 5 is based on light absorber 66 comprising 2-Hydroxy-4-n-Octoxybenzophenone. In an exemplary current embodiment of the enhanced ink 60, the selective photo absorber 66 comprises BLS 531 UV absorber, available through Mayzo Inc., of Suwanee, GAa., which is configured to provide strong absorption of UV radiation in the 300 nm to 400 nm region 88. Other embodiments of photo absorbers that can be used in enhanced inks 60 can comprise any of triazine, benzotriazole, and/or benzophenone derivatives that are substituted or bridged with polyoxyalkylene groups.

Further examples of commercially available UV Absorbers based on 2-Hydroxyphenyl-s-triazine are Tinuvin 479 (available through BASF Corporation, Resins Division, of Wyandotte, Mich.), where the absorbance drops to baseline at a wavelength below 390 nm. UV absorbers based on 2-(2-hydroxyphenyl)-Benzotriazole, such as Tinuvin 99-2 (also available through BASF Corporation), absorb light slightly above 390 nm, but will interfere only slightly with an LED lamp 122 whose wavelength is centered at 395 nm.

It should be appreciated by those skilled in the art, as a discussed above, that LED lamps that are currently available generate light with the band centered around 380 to 400 nm. The discussion above regarding FIG. 5 considers the case where a photo absorber that is included in the ink absorbs light, for example, below 390 nm.

In another illustrative embodiment, such as for one or more light emitting diodes (LEDs) 122 that generate exciting light 123 within a range of 365 to 410 nm, the photoinitiator 64 can be chosen or otherwise configured to be controllably activated within the range of 365 nm to 410 nm. In this embodiment, the photo absorber can be configured to absorb light having an average wavelength that does not substantially overlap with the range. For instance, the photo absorber can be configured to absorb light at wavelengths that are largely or substantially below that of the range.

FIG. 6 is a schematic diagram of an exemplary system 100 for delivering and curing one or more layers 46, e.g. 46a-46e, of enhanced ink 60, such as for but not limited to single pass or scanning systems 100. While the exemplary system 100 seen in FIG. 6 in regard to a drum system for supporting a flexible substrate 42, e.g. paper or film, it should be understood that the compositions 60, systems 100, and associated processes 140 (FIG. 9), can readily be applied to a wide variety of printing systems and substrates or other work pieces 42.

The exemplary system seen in FIG. 6 illustrates some of the exemplary controls and subsystems, e.g. 116, 108, 124, for controlled movement of a print drum 114, controlled delivery of ink drops 106, and controlled LED curing 150 (FIG. 9). The exemplary system embodiment seen in FIG. 6 can also preferably comprise one or more pinning stations 126, with associated controls 128.

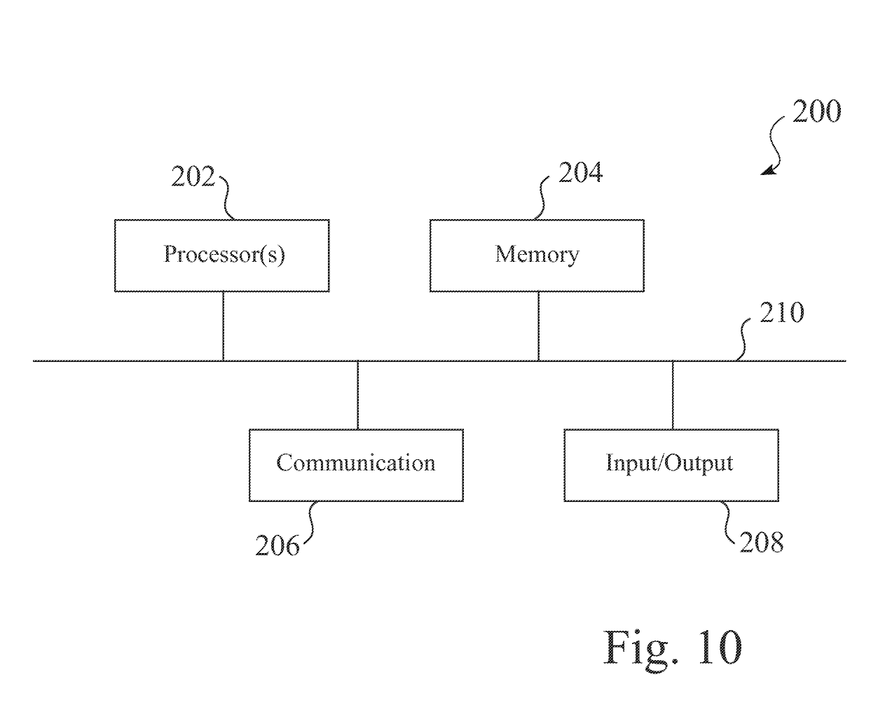

As seen in FIG. 6, movement of a print drum 114 can comprise an encoder 116 and a corresponding motor 118, wherein the encoder 116, such as linked to or associated with a central controller 110 having a processor associated therewith, e.g. such as processor 210 (FIG. 10), provides a signal or otherwise communicates with the motor 118, and wherein the motor 118 moves the print drum 114, e.g. such as directly or indirectly through a drive mechanism 120, to move the substrate 42, such as in step increments, e.g. to provide a desired resolution with delivered ink drops 106.

As also seen in FIG. 6, an ink delivery system 108, such as comprising ink cartridges, and associated plumbing, is typically driven by a central controller 110 and/or by local control, to controllably jet ink drops 106 from one or more of the print heads 104 onto the substrate 42, such as in accordance with an incoming image signal 112.

As further seen in FIG. 6, one or more LED curing stations 122 are controlled by any of a central controller 110 and/or LED curing control 108, to emit light from one or more LED elements, to cure, i.e. dry, delivered ink droplets 106 located on the substrate 42. In some embodiments, LED curing assemblies 122 are configured to deliver exciting light 123 having a wavelength centered around 410 to 380 nm, and in some current system embodiments 100, the LED curing assemblies 122 preferably have a wavelength centered around 385 to 400 nm.

The exemplary LED printer 100 seen in FIG. 6 can further comprise one or more LED pinning stations 126, such as controlled by any of a central controller 110 and/or LED pinning control 128, to emit light from one or more LED pinning elements, such as to provide sufficient power to control or stop the spread of the delivered ink drops 106 located upon the substrate 42.

FIG. 7 is a schematic diagram of an alternate exemplary system for delivering and curing one or more layers of enhanced ink, such as for a single pass roll to roll printer 100, e.g. 100a, having an LED lamp assembly 122 on one side, wherein the system 100a is configured to move 132 the substrate 142, such as supported by a platen 134, under one or more print heads 104, in the direction of the lamp 122, between a first roll 131a and a second roll 131b.

As seen in FIG. 7, movement of the substrate 42 between the rolls 131, e.g. 131a, 131b, can be controlled through an encoder 116 and a corresponding motor 135, wherein the encoder 116, such as linked to or associated with a central controller 110 having a processor associated therewith, e.g. such as processor 210 (FIG. 10), provides a signal or otherwise communicates with the motor 135, and wherein the motor 135 rotates at least one of the rolls 131, e.g. 131b, such as directly or indirectly through a drive mechanism 136, to move the substrate 42, such as in step increments, e.g. to provide a desired resolution with delivered ink drops 106.

FIG. 8 is a schematic diagram 137 of an alternate exemplary system 100 for delivering and curing one or more layers 46, e.g. 46a-46e, of enhanced ink 60, wherein the substrate 42 is supported on a platen 134. The print heads 104 and LED assemblies 122 seen in FIG. 8 are located within a print head assembly 139. The exemplary printing system seen in FIG. 8 can also preferably comprise one or more pinning stations 126, with associated controls.

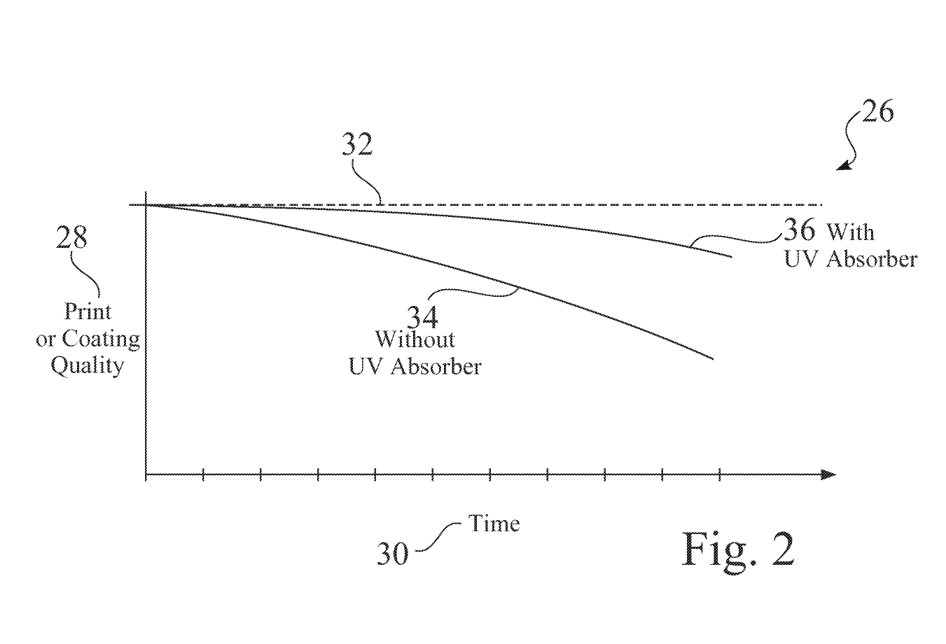

FIG. 9 is a flowchart of an exemplary process 140 for delivering and curing one or more layers 46, e.g. 46a-46e, of enhanced ink 60, to produce an enhanced print job 40, such as to preserve print quality 28 (FIG. 2) over time 30 (FIG. 2).

As seen in FIG. 9, a print system 100 is provided 142, which comprises at least one print head 104 that is configured for delivering 106 and ink jet ink 60 having a selective photo absorber 66 that is configured to absorb light in a first spectrum 88, e.g. ambient light, while having reduced absorption in one or more other spectrums 90, thus allowing a photoinitiator 64 to be properly activated by curing energy 150 and/or pinning energy 148. The provided system 100 further comprises an energy delivery mechanism 122, e.g. one or more LED curing assemblies 122, and can further comprise pinning assemblies 126.

When a substrate 42 is provided, the print system 100 is configured to deliver 146 ink drops 106 from one or more of the print heads 104 onto at least a portion of the substrate 42, such as to establish one or more layers 46, e.g. 46a-46e. If so configured, he print system 100 can power 148 one or more pinning stations 126 to provide pinning energy to the delivered ink 106, such as between the jetting 146 and curing of more than one layer 46. The print system 100 is configured to power 150 one or more LED curing stations 122, to cure the delivered ink 106, which may optionally have been previously pinned 148. If required 152,154, such as based on a print system configuration 100, or based on a print job 40, the process 140 can return 156 to deliver 146 and cure 150 more layers 46. If no additional layers 46 are required 158. The process 140 ends 160.

The enhanced inks and coatings 60 address the extent of photostability attainable with conventionally cured UV inkjet inks using photo absorbers since the same wavelengths that interact with the photoinitiators and cure the inks are those that cause photodegradation and are absorbed by the UV absorbers.

As well, the enhanced inks and coatings 60 can be loaded with large amounts of UV absorbers 66 in amounts limited only by other formulation constraints, such as viscosity and shelf life, and will not reduce the cure rate of the ink or coating 60. This is in contradistinction to the case of the conventionally cured coatings or inks, where adding a UV absorber will reduce the amount of light available to initiate the photochemical reaction meant to cure the ink or film.

Furthermore, the enhanced inks and coatings 60 can be delivered by a wide variety of existing printing systems 100, as long as the LED curing assemblies 122 have an active wavelength that is compatible with the photoinitiator 64. Therefore, no special equipment is required for most printing system implementations 100.

Although the enhanced LED curable inkjet inks, and associated systems and methods of use are described herein in connection with exemplary embodiments of print systems, the compositions and techniques can be implemented for a wide variety of printing and/or manufacturing systems and environments, or any combination thereof, as desired.

For example, alternate compositions can be provided for a wide variety of printing, painting and/or manufacturing environments. For instance, a wide variety of work pieces can readily include one or more applied layers having relatively low absorption of curing or pinning energy, and relatively high absorption of ambient energy.

FIG. 10 is a high-level block diagram showing an example of a processing device 200 that can represent any of the systems described above, such as the printing system 100, the printing system 100a, the ink delivery system 108, the drive system 116, the pinning system 128, and/or the curing system 124, Any of these systems may include two or more processing devices such as represented in FIG. 10, which may be coupled to each other via a network or multiple networks.

In the illustrated embodiment, the processing system 200 includes one or more processors 202, memory 204, a communication device 206, and one or more input/output (I/O) devices 208, all coupled to each other through an interconnect 210. The interconnect 210 may be or include one or more conductive traces, buses, point-to-point connections, controllers, adapters and/or other conventional connection devices. The processor(s) 202 may be or include, for example, one or more general-purpose programmable microprocessors, microcontrollers, application specific integrated circuits (ASICs), programmable gate arrays, or the like, or a combination of such devices. The processor(s) 202 control the overall operation of the processing device 200. Memory 204 may be or include one or more physical storage devices, which may be in the form of random access memory (RAM), read-only memory (ROM) (which may be erasable and programmable), flash memory, miniature hard disk drive, or other suitable type of storage device, or a combination of such devices. Memory 204 may store data and instructions that configure the processor(s) 202 to execute operations in accordance with the techniques described above. The communication device 206 may be or include, for example, an Ethernet adapter, cable modem, Wi-Fi adapter, cellular transceiver, Bluetooth transceiver, or the like, or a combination thereof. Depending on the specific nature and purpose of the processing device 200, the I/O devices 208 can include devices such as a display (which may be a touch screen display), audio speaker, keyboard, mouse or other pointing device, microphone, camera, etc.

Unless contrary to physical possibility, it is envisioned that (i) the methods/steps described above may be performed in any sequence and/or in any combination, and that (ii) the components of respective embodiments may be combined in any manner.

The ink delivery, pinning, curing, and/or other system functions introduced above can be implemented by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media, e.g. read-only memory (ROM); random access memory (RAM); magnetic disk storage media; optical storage media; flash memory devices; etc.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. An ink jet ink, comprising:
a carrier comprising a photocurable vehicle;
a photo absorber that is configured to absorb light at wavelengths that do not substantially overlap with that of exciting light from a light source; and
a photoinitiator that is configured to be controllably activated from the exciting light from the light source;
wherein the enhanced ink is configured to be controllably cured by the exciting light from light source to create an ink film, without substantial absorption by the photo absorber; and
wherein the photo absorber in the ink film is configured to substantially absorb incident light when the ink film is exposed to any of UVA or UVB light spectrums.

2. The ink jet ink of claim 1, further comprising:
at least one colorant.

3. The ink jet ink of claim 2, wherein the at least one colorant comprises any of a pigment or a dye.

4. The ink jet ink of claim 1, wherein the ink jet ink is substantially clear.

5. The ink jet ink of claim 1, wherein the photoinitiator is configured to be controllably pinned by a pinning light source before curing.

6. The ink jet ink of claim 1, wherein the ink jet ink is configured to increase so photostability for cured enhanced ink when the cured enhanced ink is exposed to the incident light.

7. The inkjet ink of claim 1, wherein the exciting light from the light source has an average wavelength that is within a range of 365 nm to 410 nm.

8. The ink jet ink of claim 7, wherein the range extends from 385 nm to 400 nm.

9. The ink jet ink of claim 7, wherein the photo absorber is configured to absorb light at wavelengths that are largely below that of the range.

10. A printing system creating an image on a substrate having a surface, the system comprising:
a light source that is configured to deliver exciting light; and
an ink delivery system having one or more print heads for printing ink, wherein each of the print heads has an ink channel corresponding therewith for printing an associated ink, wherein at least one of the ink channels corresponds to an enhanced ink, wherein the enhanced ink comprises
a carrier comprising a photocurable vehicle,
a photo absorber that is configured to absorb light at wavelengths that do not substantially overlap with that of the exciting light from the light source, and
a photoinitiator that is configured to be controllably activated from the exciting light from the light source;
wherein the ink delivery system is configured to controllably jet one or more layers of ink onto the substrate, wherein at least one of the layers comprises the enhanced ink;
wherein the light source is configured to controllably cure the jetted enhanced ink with the exciting light to create an ink film, without substantial absorption by the photo absorber; and
wherein the photo absorber in the ink film is configured to substantially absorb incident light when the ink film is exposed to any of UVA or UVB light spectrums.

10. printing system of claim 10, wherein the enhanced ink further comprises at least one colorant.

12. The printing system of claim 11, wherein the at least one colorant comprises any of a pigment or a dye.

13. The printing system of claim 10, wherein the printing system comprises any of a single pass printer or a scanning printer.

14. The printing system of claim 10, wherein the enhanced ink comprises any of a pigmented ink or an unpigmented ink.

15. The printing system of claim 10, wherein the ink film comprises an ink layer that is jetted directly onto the substrate.

16. The printing system of claim 10, wherein the ink film comprises a protective layer that is jetted onto one or more previously jetted ink layers on the substrate.

17. The printing system of claim 10, wherein the exciting light from the light source has an average wavelength within a range of 365 nm to 410 nm.

18. The printing system of claim 17, wherein the range extends from 385 nm to 400 nm.

19. The printing system of claim 17, wherein the photo absorber is configured to absorb light at wavelengths that are largely below that of the range.

20. A process, comprising:
providing a printing system including
a light source for delivering exciting light, and
an ink delivery system having one or more print heads for printing ink,
wherein each of the print heads has an ink channel corresponding therewith for printing an associated ink, wherein at least one of the ink channels corresponds to the enhanced ink;
providing an enhanced ink, wherein the enhanced ink comprises
a carrier comprising a photocurable vehicle,
a photo absorber that is configured to absorb light at wavelengths that do not substantially overlap with that of the exciting light from the light source, and
a photoinitiator that is configured to be controllably activated from the exciting light from the light source;
controllably jetting one or more layers of ink onto the substrate with the ink delivery system, wherein at least one of the layers comprises the enhanced ink; and
controllably curing the jetted enhanced ink with the with the exciting light from the light source to create an ink film, without substantial absorption by the photo absorber;
wherein the photo absorber in the ink film is configured to substantially absorb incident light when the ink film is exposed to any of UVA or UVB light spectrums.

21. The process of claim 20, wherein the enhanced ink further comprises at least one colorant.

22. The process of claim 21, wherein the at least one colorant comprises any of a pigment or a dye.

23. The process of claim 20, wherein the exciting light from the light source has an average wavelength that is within a range of 365 nm to 410 nm.

24. The process of claim 23, wherein the range extends from 385 nm to 400 nm.

25. The process of claim 23, wherein the photo absorber is configured to absorb light at wavelengths that are largely below that of the range.

26. The process of claim 20, wherein the enhanced ink is substantially dear.

27. The process of claim 20, wherein the photo absorber in the ink film is configured to any of reduce yellowing, retain gloss, or reduce cracking of the ink film.

28. A work product, comprising:
a work piece; and
a coating on at least a portion of the work piece, wherein the coating comprises an enhanced ink layer, wherein the enhanced ink layer is formed from an enhanced ink comprising
a carrier comprising a photocurable vehicle,
a photo absorber that is configured to absorb light at wavelengths that do not substantially overlap with that of exciting light from a light source, and
a photoinitiator that is configured to be controllably activated from the exciting light from the light source, and
wherein the enhanced ink is configured to be controllably cured by the exciting light from the light source to the enhanced ink film, without substantial absorption by the photo absorber; and
wherein the enhanced ink film is configured to substantially absorb incident light when the ink film is exposed to any of UVA or UVB light spectrums.

29. The work product of claim 28, wherein the exciting light from the light source has an average wavelength that is within a range of 365 nm to 410 nm.

30. The work product of claim 29, wherein the range extends from 385 nm to 400 nm.
